(19) United States
(12) Patent Application Publication
(10) Pub. No.: US 2008/0053503 A1
(43) Pub. Date: Mar. 6, 2008

(54) ERGONOMIC FOREARM CRUTCH

(75) Inventors: Brad J. Larson, North Logan, UT (US); Ken Lester, North Logan, UT (US)

Correspondence Address: METCALF INTELLECTUAL PROPERTY LAW, LLC, 2795 EAST COTTONWOOD PARKWAY, SUITE 155, SALT LAKE CITY, UT, 84121, US

(73) Assignee: MILLENNIAL MEDICAL EQUIPMENT, LLC, Logan, UT (US)

(21) Appl. No.: 11/854,971

(22) Filed: Sep. 13, 2007

Related U.S. Application Data
(63) Continuation-in-part of application No. 10/960,823, filed on Oct. 7, 2004.
Application No. 10/960,823 is a continuation-in-part of application No. 10/461,578, filed on Oct. 10, 2003, now Pat. No. 7,104,271.
(60) Provisional application No. 60/825,804, filed on Sep. 15, 2006.

(51) Int. Cl. A61H 3/02

(52) U.S. Cl. 135/71

(57) ABSTRACT

An ergonomic forearm crutch featuring an adjustable, ergonomic hand grip, a shock absorbing device and an ergonomically molded forearm cuff with integrated cuff hinge. The ergonomic forearm crutch is fully adjustable to meet the functional and ergonomic needs of crutch users.

### RELATED APPLICATIONS

This application is a continuation-in-part of co-pending U.S. application Ser. No. 10/960,823, filed Oct. 7, 2004, which is a continuation-in-part of U.S. Pat. No. 7,104,271. This application also claims priority to U.S. provisional patent application number 60/825,804, filed Sep. 15, 2006.

### BACKGROUND

The present invention is directed to medical devices for ambulatory care and more particularly ergonomic forearm crutches. A crutch is generally defined as a medical device that is used to support all or part of a patient's body weight. Crutches have traditionally been made of wood or metal, and are ordinarily long enough to reach from a patient's underarm to the walking surface. There is typically a concave surface fitting underneath the arm, and a cross bar for the hand, both used for supporting the body weight. Crutches may be used by a patient for only a few days or, in some instances, a lifetime.

One variation of traditional crutches is a forearm crutch. A forearm crutch, like a full-sized conventional crutch, is used to transfer part of a patient's body weight to their hands and arms while walking. As the name would indicate, forearm crutches extend from a patient's forearm rather than the patient's underarm. Forearm crutches are often employed where a patient is able to manage without the necessity of a full length crutch.

On occasion, forearm crutches have been observed to cause or lead indirectly to multiple injuries and disorders despite their ability to transfer weight and despite the fact that they are often somewhat less intrusive than traditional full-length crutches. Each repetition of usage of the crutch may be injurious and can produce micro-trauma to the tissues and joints of the body. Although the human body has enormous self-repair abilities, continued exposure to such activities can outweigh these abilities, which then results in injury.

The injuries resulting from forearm crutch use are in part due to the fact that the hand grip is rarely contoured to fit the palm of a patient's hand. The general construction and design of forearm crutch hand grips does not provide the correct ergonomic orientation between the wrist and forearm even though padding may be present. Failure to achieve correct alignment and padding in the palmar area can result in disorders of wear and tear, including overuse syndromes, repetitive strain injuries, musculoskeletal injuries, and compressive neuropathies. Common injuries resulting in such usage include: carpal tunnel syndrome, wrist tendonitis, medial or lateral elbow epicondylitis, and rotator cuff muscle strains and tears. These disorders appear to be more common in the chronic forearm crutch user, and are the result of repeated stresses on a particular musculoskeletal area.

In addition, forearm crutches suffer from some of the same problems experienced in the usage of full-length crutches. Traditional crutches fail to align the arm and hand in an ergonomic manner. Ergonomic alignment can be defined as maintenance of the arm and the wrist in a neutral position. A neutral position can be defined as placing the user's third metacarpal in general alignment with the user's radius. Patients experience more comfort and fewer injuries when they are placed in an ergonomic, neutral position. Yet most existing crutches completely fail to consider the ergonomic positioning of the patients arm, wrist, and hand, and instead simply position the hand grip horizontally outwardly from the crutch's support member. This, however, places the hand and wrist in a non-ergonomic, non-neutral position. With conventional crutches the wrist is rotated into an unnatural position. This results in a significant number of the injuries and problems mentioned above.

While various modifications have been attempted, there presently does not exist a forearm crutch that incorporates the appropriate ergonomic structure in a light-weight, sure gripping, and user friendly format.

### BRIEF SUMMARY OF THE INVENTION

The present inventions meet the above-described needs and others. Specifically the present inventions provide an ergonomically designed forearm crutch to facilitate walking and minimize injurious impact to a patient.

In one embodiment, the ergonomic forearm crutch comprises a supporting member that has a vertical axis. The support member comprises a generally vertically oriented forearm support and a generally vertically oriented hand grip portion. The crutch also includes an adjustable portion that is positioned generally along the vertical axis, the adjustable portion being attached to the supporting member. The crutch also includes a hand grip extending outwardly from the generally vertically oriented hand grip portion at an angle of about 10° to about 30° downwardly below horizontal. Alternatively, the hand grip may extend outwardly from the generally vertically oriented hand grip portion at an angle of about 15° to about 25° downwardly below horizontal. The hand grip extends outwardly from the hand grip portion at an angle such that the wrist of a user is generally maintained in a neutral position wherein the user's third metacarpal is generally aligned with the user's radius.

In addition, the hand grip may comprise a rigid core and a cover. The hand grip comprises a base, a grip axis, a palm bulge, a forefinger groove, a thumb groove, and an end guard. In some embodiments the forefinger groove curves about the grip axis at an angle ranging from about 5° to about 75° from the grip axis. The thumb groove curves about the grip axis opposite the forefinger groove at an angle ranging from about 10° to about 75° from the grip axis. In this manner the end guard prevents a hand of a user from slipping off an end of the hand grip.

As mentioned above, the crutch is configured such that when the hand grip is gripped by a user, the user's wrist is maintained in a neutral position throughout the user's walking motion. The neutral position is determined by maintenance of the user's third metacarpal generally aligned with the user's radius. This is in direct contrast to conventional crutches where the user's wrist is stressed in various ways through the walking motion.

In certain embodiments the ergonomic forearm crutch may further include a shock absorbing device having a sleeve, a spring, and shock bar, wherein the shock bar is attached to the sleeve and the spring is coupled to the shock bar, wherein the spring rate of the spring is adjustable. The crutch may also include a gripping pad coupled to the supporting member to provide stability and grip on surfaces of the walking environment, wherein the shock absorbing device is disposed between the supporting member and the gripping pad.

These and other features and advantages of the present disclosure may be incorporated into the forearm crutch and will become more fully apparent from the following description and appended claims, or may be learned by the practice and implementation of the present disclosure. As described above, the present disclosure does not require that all of the features described herein be incorporated into every embodiment nor is it required that certain features be used exclusive of other features. Ergonomic forearm crutches within the scope of the present disclosure may include one or more combinations of the features described herein.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view of an embodiment of the ergonomic forearm crutch with respect to a patient.

FIG. 2 is a side elevation view of an embodiment of the ergonomic forearm crutch.

FIG. 3 is a front elevation view of an embodiment of the ergonomic forearm crutch.

FIG. 4 is a cross-sectional side elevation view of an embodiment of the hand grip positioned at an angle in the range of about 10° to about 30° downwardly below horizontal.

FIG. 5 is a partial cross-sectional side elevation view of an embodiment of the crutch with a shock absorbing mechanism.

FIG. 6 is a partial cross-sectional side elevation view of an embodiment of the crutch shock absorbing mechanism in the relaxed position.

FIG. 7 is a partial cross-sectional side elevation view of an embodiment of the crutch sock absorbing mechanism in the compressed position.

FIG. 8 is a side elevation view of one embodiment of a hand grip.

FIG. 9 is a top view of one embodiment of a hand grip.

FIG. 10 is a opposite side elevation view of the hand grip of FIG. 8.

### DETAIL DESCRIPTION OF THE INVENTION

It will be readily understood that the components of the present disclosure, as generally described and illustrated in the figures herein, could be arranged and designed in a wide variety of different configurations. Thus, the following more detailed description, as represented in the figures, is not intended to limit the scope of the disclosure, but is merely a representative of exemplary combinations of the components.

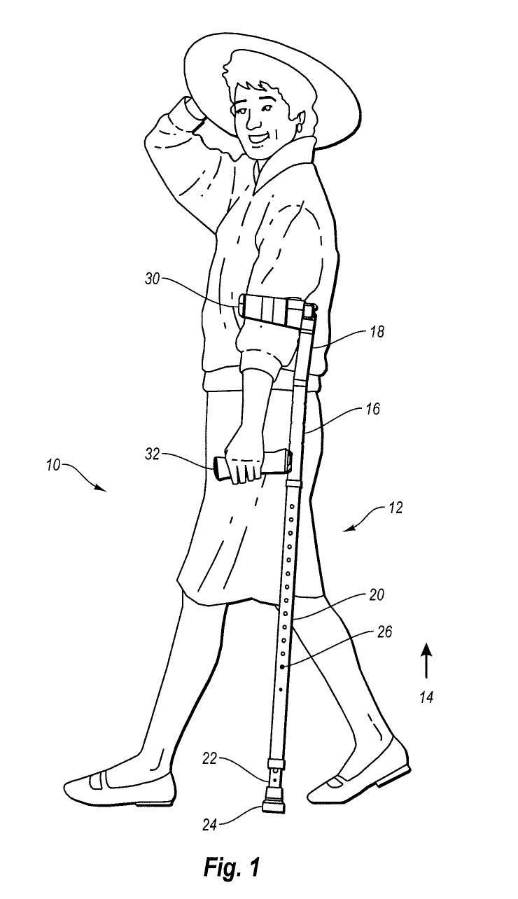

FIG. 1 illustrates an embodiment of an ergonomic forearm crutch 10 within the scope of the present invention. As illustrated in FIG. 1, the forearm crutch 10 is in use by a patient. A patient is intended to include any user of the device. As will be discussed more fully below, the forearm crutch 10 provides significant advantages over conventional forearm crutches in that it is capable of ergonomically maintaining the arm and wrist of the user in a neutral position. As discussed above, neutral position is defined as maintaining the user's third metacarpal generally aligned with the user's radius. This is achieved throughout essentially the entire walking motion of the patient.

As illustrated in FIGS. 1-3, the crutch 10 includes a supporting member 12 which supports the various structures of the crutch 10. The supporting member 12 provides support to the patient during use of the crutch. The supporting member 12 has a generally vertical axis 14. The supporting member 12 can include various sections. As illustrated in FIG. 1, these sections include a generally vertically oriented forearm support section 18. As illustrated, the forearm support section 18 may be angled slightly away from vertical in order to allow for attachment and orientation of the forearm cuff 30.

Also connected to the forearm support section 18 is a generally vertically oriented hand grip portion 16. As will be discussed in additional detail below, the hand grip portion 16 allows for attachment and orientation of the hand grip 32.

Connected to the hand grip portion 16 is a generally vertically oriented adjustable portion 20. The adjustable portion 20 each has dual snap buttons 26 which facilitate height adjustment of the crutch 10. Thus, the supporting member 12, through its components, provides support for the forearm crutch 10 structure.

The entire supporting member 12, including the hand grip portion 16, forearm support section 18, and adjustable portion 20 may be fabricated of metal such as aluminum, steel, or titanium, and are formed in a generally hollow cylindrical shape. The internal and external diameter of the supporting member 12 and the various sections thereof can be of varying dimensions to accommodate a patient's needs and to provide for the pieces of the crutch to fit together. For example, a pediatric patient may utilize a crutch with a smaller external diameter than an adult patient.

Also illustrated in FIG. 1 is a shock absorbing portion 22. In some embodiments the shock absorbing portion 22 may include a spring mechanism for absorbing shock. These embodiments will be discussed in additional detail below. Attached to the base of the shock absorbing portion 22 is a gripping pad 24. The gripping pad 24 may be a conventional grip of the type generally use in crutches.

The shock absorbing portion 22 may be used at the distal end of the adjustable portion 20 to assist in ambulating over uneven surfaces and to provide a cushioning effect. The distal end of the crutch has a gripping pad 24 that provides appropriate friction between the crutch 10 and the walking environment. The gripping pad 24 may be formed of an elastomeric material such as EVA, urethane foam, neoprene foam, PVC, natural rubber, cork or any other possible materials.

As indicated above, the adjustable portion 20 of the supporting member 12 includes dual snap buttons 26 to accommodate patients of varying heights. Alternative devices may be used as a latching mechanisms instead of the illustrated dual snap buttons 26. For example, a single pin radially biased outward would be sufficient.

The hand grip 32 is attached to the hand grip portion 16 of the supporting member 12 in such a manner that the forearm crutch 10 is ergonomic, as that term has been defined above. In particular, the hand grip 32 is provided with appropriate contours and ergonomic angulation to fit the palm and align the wrist. The hand grip 32 may be fabricated of elastomeric material such as EVA, urethane foam, neoprene foam, PVC, natural rubber, cork or any other possible materials.

The hand grip 32 is adjustable to maintain the wrist of a patient in the neutral position, which position has been described as a line passing though the middle of the third metacarpal being parallel to a line passing through the middle of the radius. The adjustability of hand grip 32 allows for easier grip, decreased stress and decreased risk of injury to the wrist. The ergonomic design of the hand grip 32 encourages spreading of the force load from grasping forces over as large an area as possible.

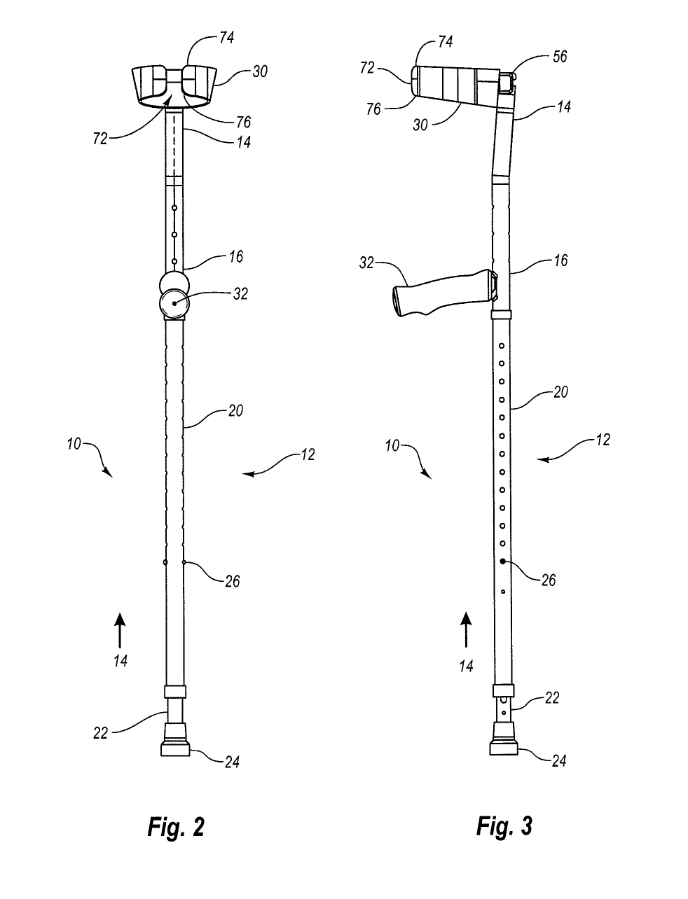

Also as illustrated in FIG. 2, the cuff 30 is molded in a v-shape so that the cuff diameter at the top of the cuff is wider than the diameter at the bottom of the cuff thereby creating an ergonomic contour similar to the contour of the user's forearm. Additionally, the cuff opening 72 is molded in a v-shape such that the top 74 of the cuff opening 72 is wider than the bottom 76 of the cuff opening 72. In one embodiment of the ergonomic cuff 30, the width at the top 74 of the cuff opening 72 is in the range of about 0.5 to about 1.25 inches or from about 12.7 to about 31.75 millimeters and more preferably at the width of 0.875 inches or 22.2 millimeters, while the width at the bottom 76 of the cuff opening 72 is in the range of about 0.1 to about 0.4 inches or from about 2.54 to about 10.16 millimeters and more preferably at the width of 0.25 inches or 6.35 millimeters. While it is anticipated that the overall diameter of the cuff 30 may change to accommodate different sizes of forearms, the range of the cuff opening 72 will remain within the ranges as discussed above.

As illustrated in FIG. 3, the cuff hinge 56 is integrated into the cuff 30 so that the cuff 30 and the cuff hinge 56 are one piece of molded material thereby reducing the number of individual parts needed for adjustment of the cuff 30 angle with respect to the vertical axis 14.

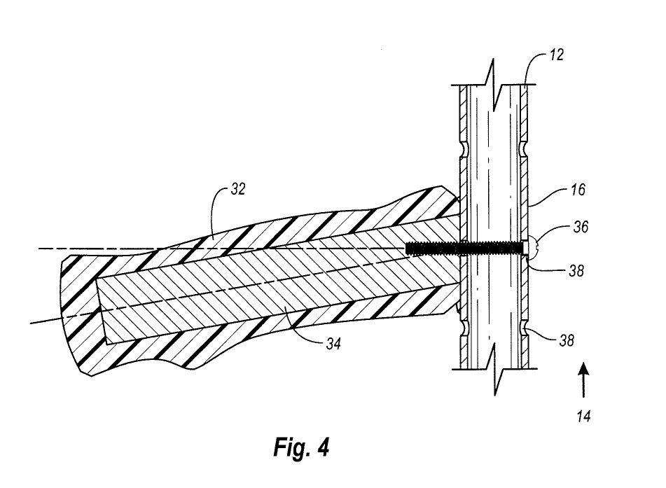

As illustrated in FIG. 4, the hand grip 32 is connected to the hand grip portion 16 of the supporting member 12 via a hand grip shaft 34. In one embodiment of the ergonomic forearm crutch, the hand grip 32 is secured to the supporting member 12 via a machine screw 36 that extends through a set of hand grip adjustment apertures 38.

The hand grip 32 may be of varying diameters to accommodate the palm of a patient. In one embodiment of the ergonomic forearm crutch, the hand grip 32 is about 1 cm smaller than a patient's inside grip diameter. The pressure of the hand grip 32 on the hand should be distributed over the fat pads of the hands. The contour of the hand grip 32 corresponds with the curve of the transverse palmar arch and the natural palmar curve of the fingers as they flex toward the palm.

The length of the hand grip 32 should be long enough to evenly distribute the grasping forces over the palm of the hand. A grip with a length in the range of about 4 to about 5 inches or from about 10 to about 12 centimeters provides sufficient area to spread the grasping force over the palm of an average adult patient. However, the length of the hand grip 32 may be customized to the palm of any patient.

The hand grip 32 is oriented to maintain the wrist in a neutral position throughout a patient's walking motion. The neutral position is generally maintained by keeping a patient's third metacarpal generally aligned with his radius. Therefore, the hand grip 32 is angled downwardly from the horizontal axis at an angle allowing for a patient's third metacarpal to be more generally aligned with his radius. The edge of the hand grip shaft 34 that contacts the supporting member 12 may be manufactured to provide complete contact such that when the hand grip 32 is at an angle there is little to no gap between the edge of the hand grip portion 16 and the supporting member 12. The angle is determined by a variety of factors including the particular physical structure of the patient's hand, arm, and wrist, as well as person preference.

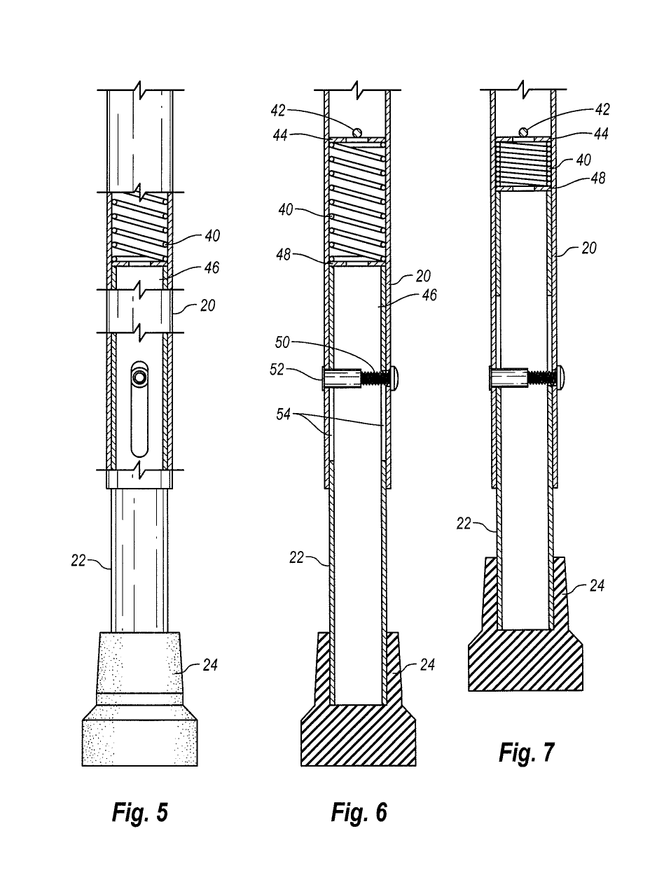

A shock absorbing portion 22 may be included in an ergonomic forearm crutch 10. FIGS. 1-3 illustrate a crutch 10 in an assembled position, where the crutch is ready for use by a user to provide assistance with ambulatory movement of the user. FIGS. 5-7 illustrate one embodiment of the shock absorbing portion 22. In one embodiment, a spring 40 is used to provide a shock absorbing mechanism, as illustrated in FIGS. 5-7. Alternative shock absorbing devices are possible, including but not limited to gas assisted shocks, hydraulic shocks and pneumatic shocks. The spring 40 is contained within the lower half of the adjustable portion 20. The proximal end of the spring 40 is held in place with a retaining pin 42 and an upper retaining washer 44. The distal end of the spring 40 contacts the proximal end portion of the shock bar 46 via a lower retaining washer 48. The shock bar 46 has a smaller external diameter than the internal diameter of the adjustable portion 20, such that the shock bar 46 can telescope into and out of the adjustable portion as required by the pressure exerted by a patient. A machine screw 50 connected with a tee nut 52 secures the adjustable portion 20 to the shock bar 46. The tee nut 52 extends through a longitudinally elongated aperture 54 in which the machine screw 50 connected with the tee nut 52 can slide.

FIG. 6 illustrates a shock absorbing portion 22 in its relaxed state such that the spring 40 is extended. FIG. 7 illustrates a shock absorbing portion in its compressed state such that the spring 40 is compressed. The shock bar 46 is finished off at its end with a gripping pad 24 that acts as a support element on the ground. This pad 24 is made of the appropriate elastomeric material with its gripping surface ribbed, corrugated, spiked, or otherwise made to grip the surface to reduce friction. The pad 24 is made such that the proximal portion of the pad 24 fits onto the distal end of the crutch, with an articulation with the distal portion such that it can accommodate 120 degrees of motion. The articulation may include a hinge, ball in socket, sliding joint, or other means to allow for movement.

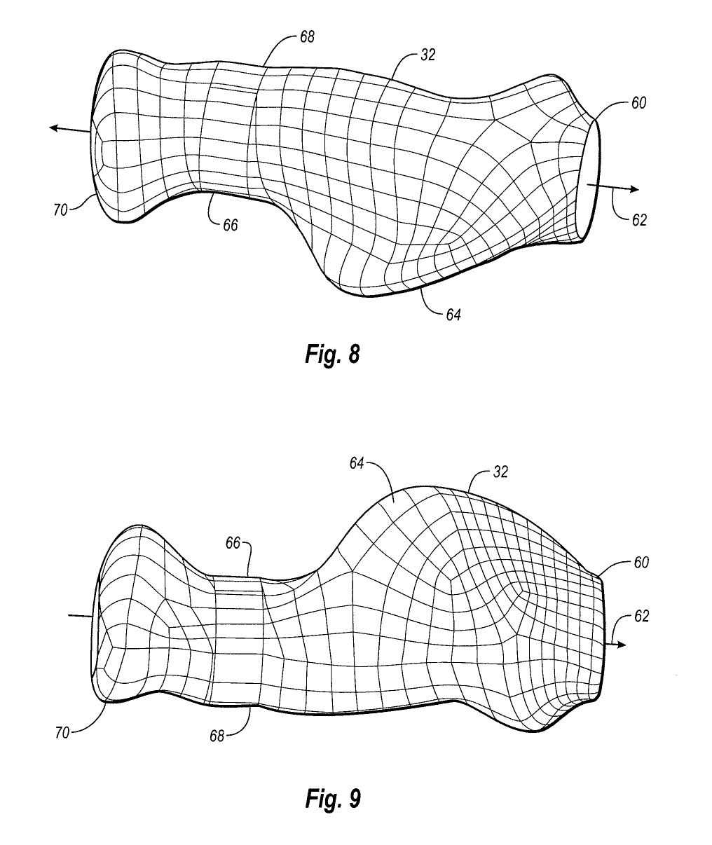

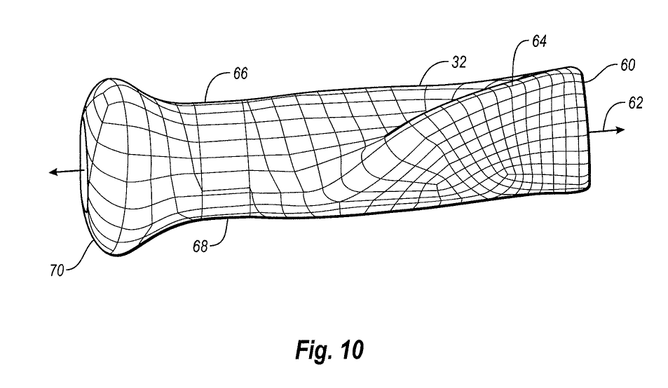

Referring to FIGS. 8-10, a side elevation view, a top view, and an opposite side elevation view illustrate one embodiment of hand grip 32 or use with the crutch 10. The hand grip 32 includes a base 60 for attachment directly to a supporting member 12 or attached to an alternative attachment mechanism (not shown). The hand grip 32 also includes a grip axis 62, a palm bulge 64, a forefinger groove 66, a thumb groove 68, and an end guard 70.

The forefinger groove 66 curves about the grip axis 62 at an angle ranging from about 5° to about 75° from the grip axis 62. The forefinger groove 66 may also curve about the grip axis 62 at an angle ranging from about 5° to about 85° from the grip axis 62. The thumb groove 68 curves about the grip axis 62 opposite the forefinger groove 66 at an angle ranging from about 10° to about 75° from the grip axis 62. The thumb groove 68 may also curve about the grip axis 62 opposite the forefinger groove 66 at an angle ranging from about 5° to about 85° from the grip axis 72. The end guard 70 helps to prevent a hand of a user from slipping off an end of the hand grip 32. This ergonomic design of the hand grip 32 allows a user to grip the hand grip 32 by the hand in a natural and unstrained position.

Any of the features or elements described in any of the embodiments herein may be combined with any other feature or element described herein to achieve the purposes of the invention as claimed. It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure, the presently filed claims, or subsequently filed claims recite “a” or “a first” element or the equivalent thereof, it should be within the scope of the present inventions that such disclosure or claims may be understood to include incorporation of one or more such elements, neither requiring nor excluding two or more such elements.

Applicants submit claims herewith and reserve the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure.

1. An ergonomic forearm crutch comprising:
a supporting member that has a vertical axis, the support member comprising a generally vertically oriented forearm support and a generally vertically oriented hand grip portion, and a generally vertically oriented adjustable portion; and
a hand grip extending outwardly from the hand grip portion at an angle of about 10° to about 30° downwardly below horizontal, wherein the hand grip extends outwardly from the hand grip portion at an angle such that the wrist of a user is generally maintained in a neutral position such that the user's third metacarpal is generally aligned with the user's radius.

2. The ergonomic forearm crutch of claim 1 wherein the hand grip extends outwardly from the generally vertically oriented hand grip portion at an angle of about 15° to about 25° downwardly below horizontal.

3. The ergonomic forearm crutch of claim 1, wherein the hand grip comprises a rigid core and a cover, wherein the hand grip comprises a base, a grip axis, a palm bulge, a forefinger groove, a thumb groove, and an end guard, wherein the forefinger groove wraps around the grip axis at an angle ranging from about 5° to about 85° from the grip axis, and wherein the thumb groove curves about the grip axis opposite the forefinger groove at an angle ranging from about 10° to about 75° from the grip axis.

4. The ergonomic forearm crutch of claim 1, wherein when the hand grip is gripped by a user, the user's wrist is maintained in a neutral position throughout the user's walking motion while using the ergonomic forearm crutch.

5. The ergonomic forearm crutch of claim 1, wherein the supporting member has a plurality of hand grip adjustment apertures, wherein the handgrip is removably attachable to the supporting member at one of the plurality of hand grip adjustment apertures.

6. The ergonomic forearm crutch of claim 1, wherein the ergonomic forearm crutch further comprises a shock absorbing device.

7. The ergonomic forearm crutch of claim 6, wherein the shock absorbing device comprises a sleeve, a spring, and shock bar, wherein the shock bar is attached to the sleeve and the spring is coupled to the shock bar, wherein the spring rate of the spring is adjustable.

8. The ergonomic forearm crutch of claim 1, further comprising a gripping pad coupled to the supporting member to provide stability and grip on surfaces of the walking environment.

9. The ergonomic forearm crutch of claim 1, further comprising a forearm cuff hingedly coupled to the supporting member.

10. The ergonomic forearm crutch of claim 9, wherein the forearm cuff is molded in a v-shape thereby creating an ergonomic contour.

11. The ergonomic forearm crutch of claim 10, wherein the top diameter of the forearm cuff is larger than the bottom diameter of the forearm cuff.

12. The ergonomic forearm crutch of claim 9, further comprising a forearm cuff hinge coupled to the forearm cuff and adjustably attached to the supporting member thereby allowing for the adjustment of the forearm cuff to suit the needs of the crutch user.

13. The ergonomic forearm crutch of claim 12, wherein the forearm cuff hinge and the forearm cuff are one molded unit.

14. An ergonomic forearm crutch comprising:
support means, said support means comprising a supporting member that has a vertical axis, the support member comprising a generally vertically oriented forearm support and a generally vertically oriented hand grip portion, and a generally vertically oriented adjustable portion; and
grip means for maintaining the wrist of a user in a neutral position through out the user's walking motion while using the ergonomic forearm crutch.

15. The ergonomic forearm crutch of claim 14 wherein the grip means comprises a hand grip extending outwardly from the generally vertically oriented hand grip portion at an angle of about 10° to about 30° downwardly below horizontal, and wherein the hand grip extends outwardly from the hand grip portion at an angle such that the wrist of a user is generally maintained in a neutral position such that the user's third metacarpal is generally aligned with the user's radius.

16. The ergonomic forearm crutch of claim 15 wherein the hand grip extends outwardly from the generally vertically oriented hand grip portion at an angle of about 15° to about 25° downwardly below horizontal.

17. The ergonomic forearm crutch of claim 15, wherein the hand grip comprises a rigid core and a cover, wherein the hand grip comprises a base, a grip axis, a palm bulge, a forefinger groove, a thumb groove, and an end guard.

18. The ergonomic forearm crutch of claim 15 wherein the supporting member has a plurality of hand grip adjustment apertures, wherein the handgrip is removably attachable to the supporting member at one of the plurality of hand grip adjustment apertures.

19. The ergonomic forearm crutch of claim 15, wherein the ergonomic forearm crutch further comprises a shock absorbing device.

20. The ergonomic forearm crutch of claim 15 further comprising a gripping pad coupled to the supporting member to provide stability and grip on surfaces of the walking environment.

21. A method of maintaining the wrist of a forearm crutch user in a neutral position throughout the user's walking motion comprising:
providing a supporting member that has a vertical axis, the support member comprising a generally vertically oriented forearm support and a generally vertically oriented hand grip portion, an adjustable portion that is positioned generally along the vertical axis, the adjustable portion being attached to the supporting member; and
providing a hand grip extending outwardly from the generally vertically oriented hand grip portion at an angle of about 10° to about 30° downwardly below horizontal, and wherein the hand grip extends outwardly from the hand grip portion at an angle such that the wrist of a user is generally maintained in a neutral position such that the user's third metacarpal is generally aligned with the user's radius.

22. The method of claim 21 wherein the hand grip extends outwardly from the generally vertically oriented hand grip portion at an angle of about 15° to about 25° downwardly below horizontal.
